(19) United States
(12) Patent Application Publication
(10) Pub. No.: US 2024/0322510 A1
(43) Pub. Date: Sep. 26, 2024

(54) SHIELD TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kazuaki HAMADA, Osaka (JP); Liping KANG, Mie (JP)

(21) Appl. No.: 18/600,081

(22) Filed: Mar. 8, 2024

(30) Foreign Application Priority Data
Mar. 22, 2023 (JP) 2023-045096

(51) Int. Cl. H01R 43/02; H01R 24/44

(52) U.S. Cl. CPC H01R 43/0263; H01R 24/44; H01R 43/0221

(57) ABSTRACT

It is aimed to provide a shield terminal capable of ensuring the stability of welding and improving workability at the time of assembly. An outer conductor of a shield terminal 10 includes a first outer conductor 20A and a second outer conductor 20B. The first outer conductor 20A has a tubular shape and includes a first end part 24. The second outer conductor 20B has a tubular shape and includes a second end part 32 to be arranged inside the first end part 24. Either one of the first and second end parts 24, 32 includes a protrusion 28 projecting toward the other and having a tip in contact with the other.

### CROSS-REFERENCE TO RELATED APPLICATIONS

This application is based on and claims priority from Japanese Patent Application No. 2023-045096, filed on Mar. 22, 2023, with the Japan Patent Office, the disclosure of which is incorporated herein in its entirety by reference.

### TECHNICAL FIELD

The present disclosure relates to a shield terminal.

### BACKGROUND

A shield terminal disclosed in International Application Publication No. WO 2017/144070 is provided with an outer conductor including an outer conductor front part and an outer conductor rear part. A tip part of the outer conductor rear part is fit into the outer conductor front part and coupled to the outer conductor front part by applying welding to a fitting part.

### SUMMARY

In the configuration of International Application Publication No. WO 2017/144070, it has been necessary to manage a clearance between the inner peripheral surface of the outer conductor front part and the outer peripheral surface of the outer conductor rear part with high accuracy in the fitting part of the outer conductor. For example, if the clearance is large, there has been a problem of unstable welding. In contrast, for example, if the clearance is small, there has been a problem that assembly resistance becomes excessive in a fitting step of the outer conductor front part and the outer conductor rear part and workability is deteriorated.

Accordingly, the present disclosure aims to provide a shield terminal capable of ensuring the stability of welding and improving workability at the time of assembly.

The present disclosure is directed to a shield terminal with an inner conductor, an outer conductor for surrounding the inner conductor, and a dielectric to be interposed between the inner conductor and the outer conductor, the outer conductor including a first outer conductor and a second outer conductor, the first outer conductor having a tubular shape, the first outer conductor including a first end part, the second outer conductor having a tubular shape, the second outer conductor including a second end part to be arranged inside the first end part, and either one of the first and second end parts including a protrusion projecting toward the other and having a tip in contact with the other.

According to the present disclosure, it is possible to provide a shield terminal capable of ensuring the stability of welding and improving workability at the time of assembly.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side view in section of a shield terminal connected to an end part of a shielded cable in a first embodiment of the present disclosure.

FIG. 2 is a side view of the shield terminal connected to the end part of the shielded cable shown in FIG. 1.

FIG. 3 is a transverse section of the shield terminal connected to the end part of the shielded cable shown in FIG. 1.

FIG. 4 is a partial enlarged side view in section showing a state where the tip of a protrusion is joined in contact with the outer peripheral surface of a second end part in the first embodiment.

FIG. 5 is a back view of a first outer conductor shown in FIG. 1.

FIG. 6 is a perspective view showing a state where a rear part of a second outer conductor is opened in a manufacturing process of the shield terminal shown in FIG. 1.

FIG. 7 is a view, corresponding to FIG. 4, of a second embodiment of the present disclosure.

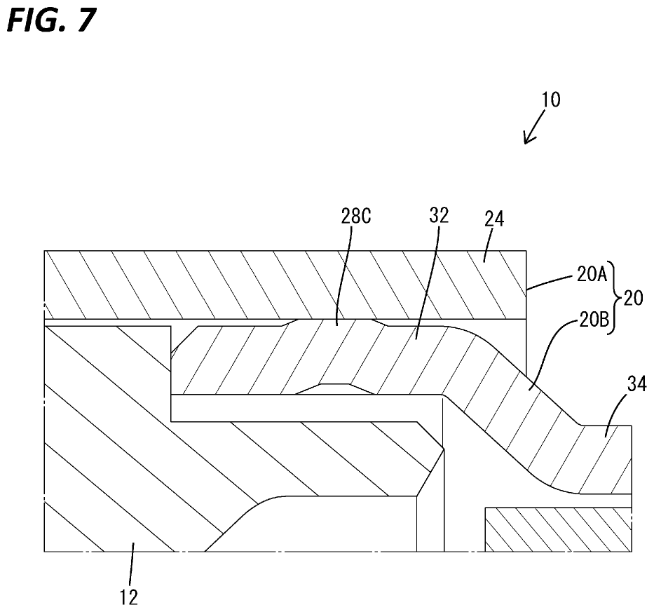

FIG. 8 is a view, corresponding to FIG. 4, of a third embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The shield terminal of the present disclosure is provided with an inner conductor, an outer conductor for surrounding the inner conductor, and a dielectric to be interposed between the inner conductor and the outer conductor, the outer conductor including a first outer conductor and a second outer conductor, the first outer conductor having a tubular shape, the first outer conductor including a first end part, the second outer conductor having a tubular shape, the second outer conductor including a second end part to be arranged inside the first end part, and either one of the first and second end parts including a protrusion projecting toward the other and having a tip in contact with the other.

Since the protrusion of the one end part in contact with the other end part can be used as a welding point in assembling the first and second outer conductors in the above configuration, the first end part of the first outer conductor and the second end part of the second outer conductor can be stably welded. In the process of assembling the first and second outer conductors, the tip of the protrusion can remain in contact with the other end part, wherefore assembly resistance needs not be increased and workability at the time of assembly can be improved.

(2) Preferably, in the shield terminal described in (1) above, the first end part is continuous in a circumferential direction via a cut, and the protrusion is provided in a quadrant range in the circumferential direction from the cut in the one end part.

In the above configuration, the first end part can be resiliently opened via the cut when the tip of the protrusion contacts the other end part. Since the protrusion is provided in the quadrant range in the circumferential direction from the cut, the assembly resistance of the first and second outer conductors can be reduced and workability at the time of assembly can be further improved, for example, as compared to the case where the protrusion is provided outside the quadrant range.

(3) Preferably, in the shield terminal described in (1) or (2) above, the first end part includes a stabilizer formed by bending and raising an inner part of a cut portion formed in the first end part, and the protrusion is provided at a position near the cut portion in the one end part.

In the above configuration, the first end part can be resiliently opened via the cut portion when the tip of the protrusion contacts the other end part. Since the protrusion is provided at the position near the cut portion, the assembly resistance can be reduced and workability at the time of assembly can be further improved. Note that the “position near the cut portion” is a position where the first end part can be resiliently opened while the cut portion is deformed by the protrusion provided at this near position at the time of assembling the first and second outer conductors.

(4) Preferably, in the shield terminal described in any one of (1) to (3) above, the tip of the protrusion is a flat surface.

Since the flat surface of the protrusion is in contact with the other end part in the above configuration, a large contact area between the first and second end parts can be secured and the stability of welding can be further improved.

(5) Preferably, in the shield terminal described in any one of (1) to (4) above, if the one end part is equally and virtually divided into four in the circumferential direction to form four divided portions, the protrusions are respectively separately provided in the four divided portions.

Since the protrusions, which can serve as welding points, can be arranged at equal intervals or nearly at equal intervals in the circumferential direction of the one end part, a path for a return current can be secured in the outer conductor and shielding performance of the outer conductor can be properly exhibited.

(6) Preferably, in the shield terminal described in any one of (1) to (5) above, the protrusion is provided on the first end part, and an outer peripheral surface of the first end part includes a recess at a position corresponding to the protrusion.

Since the recess in the outer peripheral surface of the first end part can be, for example, visually confirmed and used as a welding point in the above configuration, workability in welding the first and second end parts can be improved.

### Details of Embodiments of Present Disclosure

Specific examples of the present disclosure are described below with reference to the drawings. Note that the present invention is not limited to this illustration, but is represented by claims and intended to include all changes in the scope of claims and in the meaning and scope of equivalents.

### First Embodiment

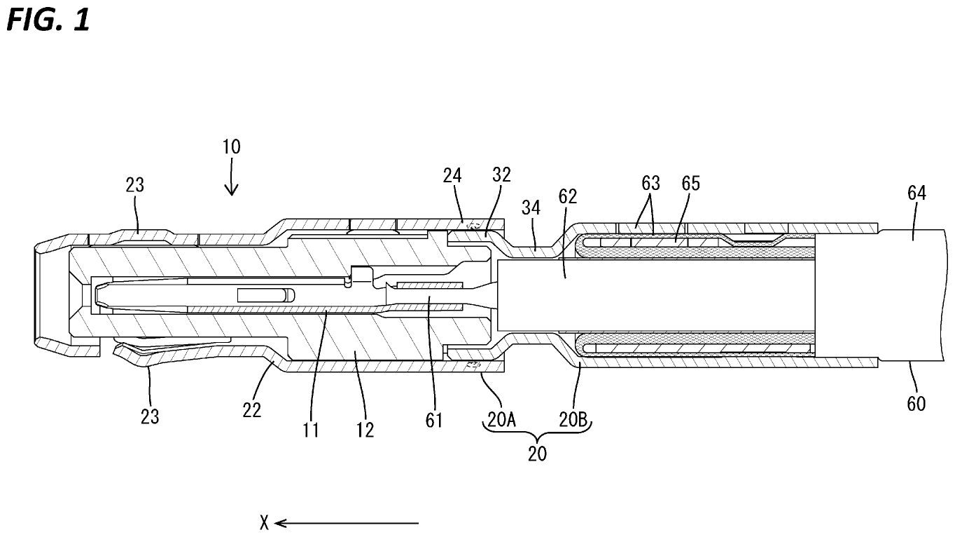

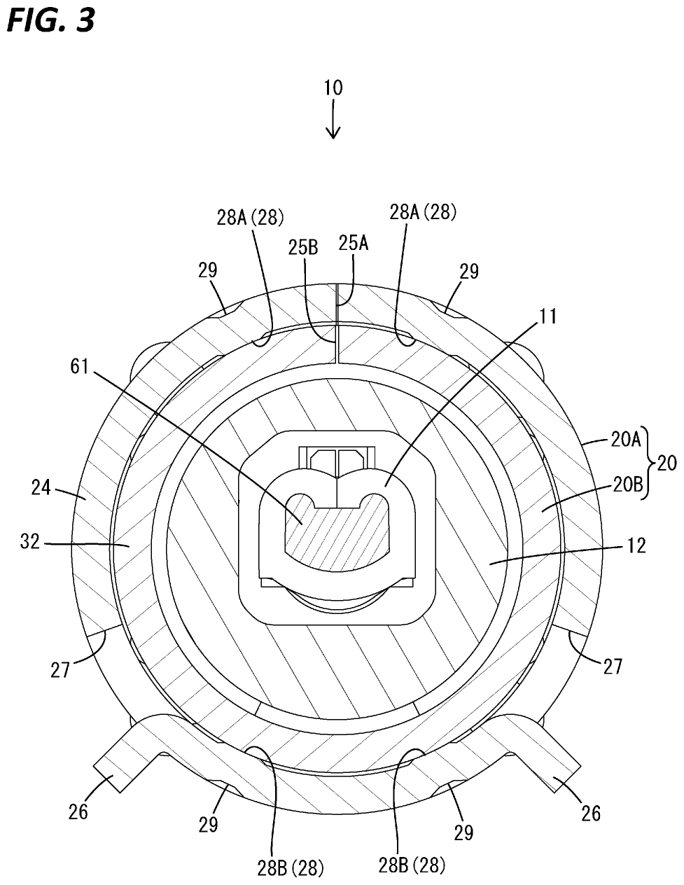

A shield terminal 10 according to the first embodiment is provided with an electrically conductive inner conductor 11, an insulating dielectric 12 and an electrically conductive outer conductor 20 as shown in FIG. 1. The inner conductor 11 is connected to an end part of a shielded cable 60. The shield terminal 10 is accommodated into an unillustrated housing and constitutes a shield connector together with the housing. Note that, in the following description, a side of the shield terminal 10 to be connected to the shielded cable 60 is referred to as a front side concerning a front-rear direction. A side indicated by an arrow X of FIG. 1 is a front side. A lateral direction is based on a lateral direction of FIG. 3. A vertical direction is based on a vertical direction of each figure. In this specification, the lateral direction is synonymous with a width direction, and the vertical direction is synonymous with a height direction. These directions are merely determined for convenience.

### Inner Conductor 11 and Dielectric 12

The inner conductor 11 is made of electrically conductive metal and, for example, configured as a female terminal. As shown in FIG. 1, the inner conductor 11 is connected to a core wire 61 exposed in the end part of the shielded cable 60.

The dielectric 12 is made of synthetic resin and accommodates the inner conductor 11 inside. The dielectric 12 is arranged between the outer conductor 20 and the inner conductor 11 to maintain the outer conductor 20 and the inner conductor 11 in an insulated state.

### Outer Conductor 20

The outer conductor 20 is formed, such as by bending an electrically conductive metal plate material. The outer conductor 20 surrounds the outer periphery of the inner conductor 11 to shield the inner conductor 11 from electromagnetic noise. The outer conductor 20 includes a first outer conductor 20A having a tubular shape, e.g. a hollow cylindrical shape, and a second outer conductor 20B likewise having a tubular shape, e.g. a hollow cylindrical shape.

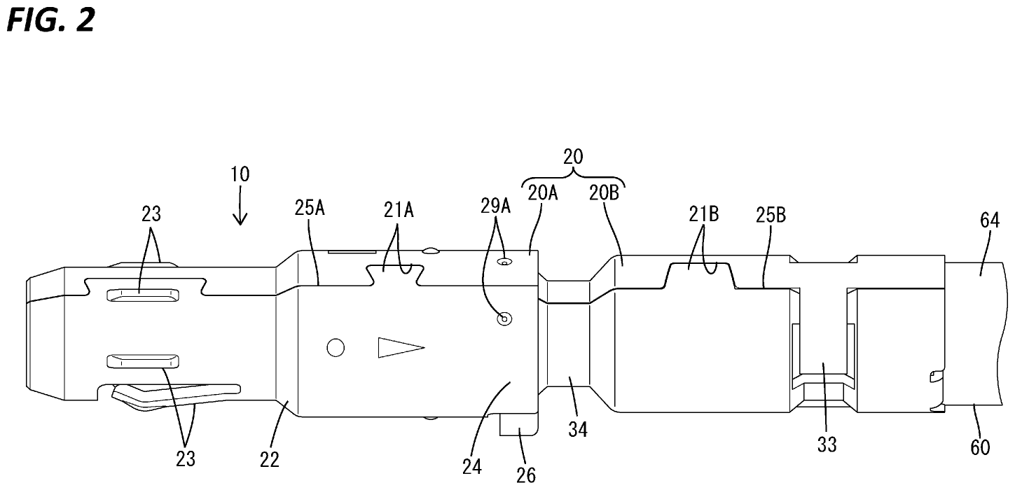

The first outer conductor 20A accommodates the dielectric 12 inside. The first outer conductor 20A is bent into a tubular shape and configured by joining both ends of a cut 25A (also a seam) in a circumferential direction as shown in FIG. 2. Locking portions 21A in the form of a recess and a projection to be fit to each other are formed on the both ends in the circumferential direction of the first outer conductor 20A. The first outer conductor 20A maintains the tubular shape by the locking portions 21A.

The first outer conductor 20A includes a step portion 22 in an intermediate part in the front-rear direction and, out of both front and rear sides across the step portion 22, the front side is configured to have a smaller diameter than the rear side. As shown in FIG. 1, the dielectric 12 is arranged to be able to contact the step portion 22 from behind while being accommodated in the rear side of the first outer conductor 20A. A plurality of contact point portions 23 are provided at intervals in the circumferential direction on the front side of the first outer conductor 20A. Each contact point portion 23 is composed of a movable part and a fixed part and contacts an unillustrated mating outer conductor to connect the outer conductor 20 and the mating outer conductor.

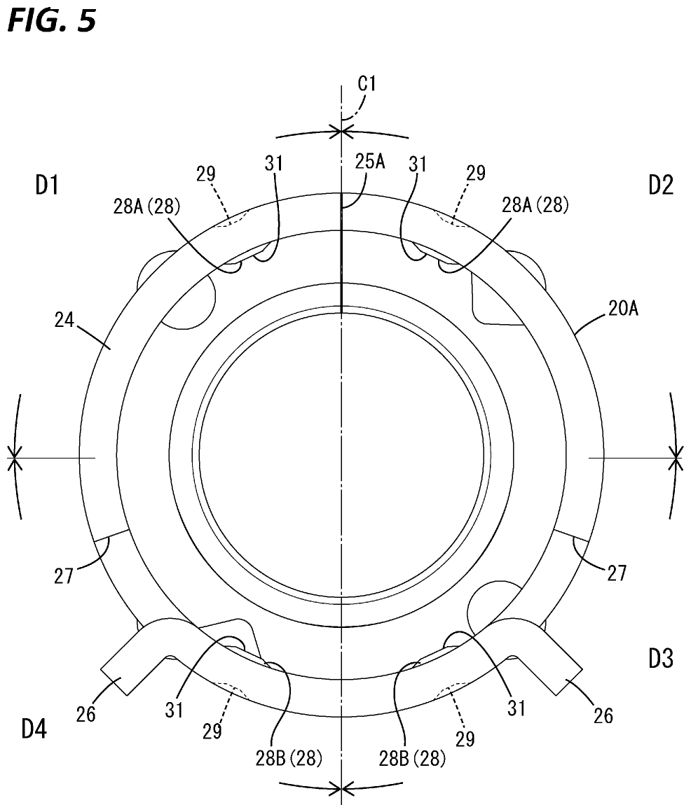

A rear end part of the rear side of the first outer conductor 20A serves as a first end part 24 to be coupled to the second outer conductor 20B. As shown in FIG. 5, the first end part 24 includes a pair of stabilizers 26 in a half-circumference range (a lower half of FIG. 5 and a range having divided portions D3, D4 to be described later) on a side opposite to a half-circumference range (an upper half of FIG. 5 and a range having divided portions D1, D2 to be described later) centered on the cut 25A. The respective stabilizers 26 are provided line-symmetrically across an axis of symmetry Cl passing through a radial center of the first outer conductor 20A and the cut 25A.

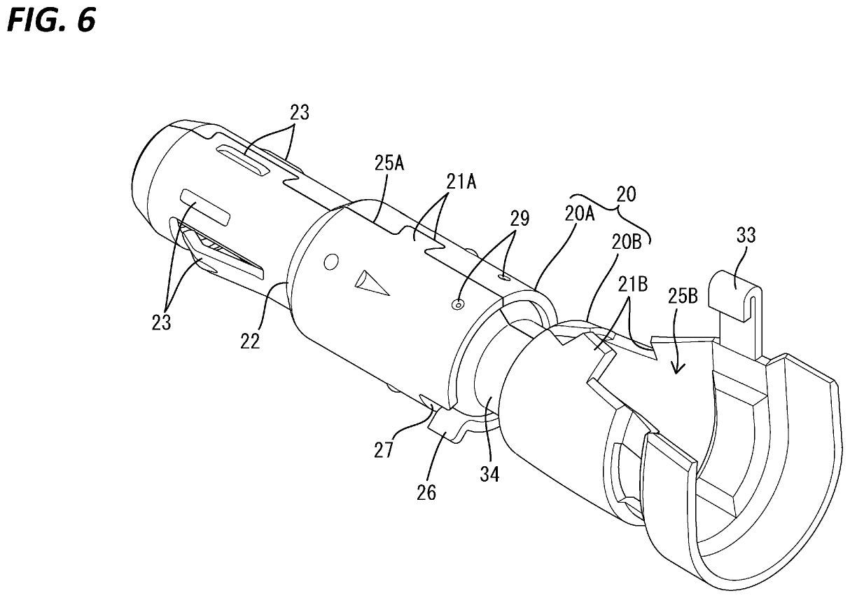

As shown in FIG. 2, the stabilizer 26 is in the form of a plate rectangular in a side view, and arranged with plate thickness surfaces facing toward both front and rear sides. As shown in FIG. 6, the stabilizer 26 is formed by bending and raising an inner part of an L-shaped cut portion 27 open in the rear end of the first end part 24 radially outward. Although not shown, an inserting operation of the shield terminal 10 into the housing is guided by fitting the respective stabilizers 26 into guide grooves formed in the housing and advancing the respective stabilizers 26. Further, by fitting the respective stabilizers 26 into the guide grooves of the housing and advancing the respective stabilizers 26, the shield terminal 10 is restricted from rotating about an axis with respect to the housing. Further, erroneous insertion of the shield terminal 10 into the housing is also restricted by the respective stabilizers 26.

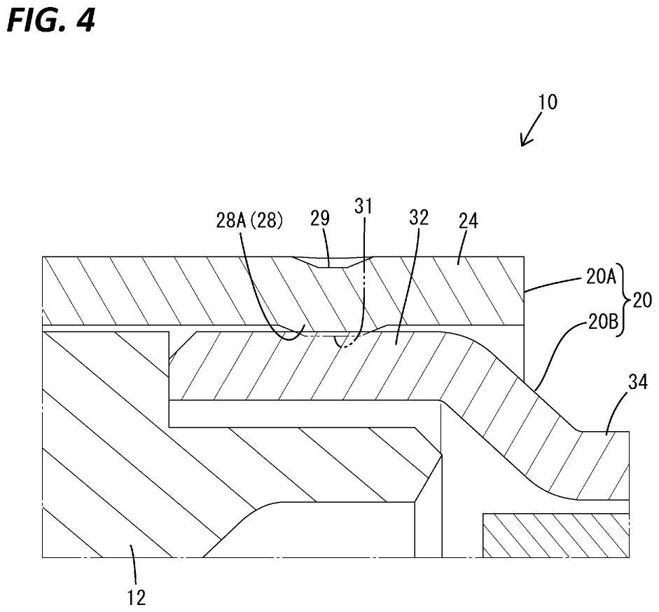

As shown in FIG. 5, the first outer conductor 20A includes a plurality of protrusions 28 arranged at intervals in the circumferential direction in the first end part 24. Each protrusion 28 is formed by press-working the outer peripheral surface of the first end part 24. Each protrusion 28 has an embossed shape projecting (bulging) radially inwardly of the first end part 24. Recesses 29 associated with press working are formed at positions corresponding to the protrusions 28 in the outer peripheral surface of the first end part 24. As shown in FIG. 2, the recess 29 has a circular contour when viewed from a radially outer side. The protrusion 28 also has a circular contour when viewed from a radially inner side. The tip of the protrusion 28 in a projection direction is a planar flat surface 31 as shown in FIG. 5. As shown in FIG. 4, the flat surface 31 of the protrusion 28 is linearly arranged in a cross-sectional view of the first end part 24.

The respective protrusions 28 include two protrusions (hereinafter, referred to as first protrusions 28A) arranged in the half-circumference range (the upper half of FIG. 5 and the range having divided portions D1, D2 to be described later) centered on the cut 25A and two protrusions (hereinafter, referred to as second protrusions 28B) arranged in the half-circumference range (the lower half of FIG. 5 and the range having divided portions D3, D4 to be described later) including the respective stabilizers 26.

The first protrusions 28A are respectively arranged at line-symmetrical positions across the axis of symmetry C1. In the case of the first embodiment, the respective first protrusions 28A are arranged at an interval of 90° via the cut 25A in the circumferential direction of the first end part 24. That is, each first protrusion 28A is arranged in one quadrant range in the circumferential direction of the first end part 24. In a shown case, the first protrusions 28A are respectively arranged in the quadrant ranges from the cut 25A and in the divided portions D1, D2.

The second protrusions 28B are respectively arranged at line-symmetrical positions across the axis of symmetry C1. In the case of the first embodiment, the respective second protrusions 28B are arranged at an interval of less than 90° via a lower end position (position, through which the axis of symmetry C1 passes) on a side radially opposite to the cut 25A in the circumferential direction of the first end part 24. The respective second protrusions 28B are arranged near base end parts of the respective stabilizers 26 and the respective cut portions 27 in the circumferential direction of the first end part 24. The second protrusions 28B are respectively arranged in the divided portions D3, D4.

In the case of forming four divided portions D1 to D4 (see arrow ranges of FIG. 5) by equally and virtually dividing the first end part 24 at intervals of 90°, the respective protrusions 28 (first protrusions 28A and second protrusions 28B) are separately arranged in the four divided portions D1 to D4. Note that, in the case of the first embodiment, it is assumed, for the sake of convenience, that the first end part 24 is divided into the divided portion D1, which is a quadrant part on an upper left side of FIG. 5, the divided portion D2, which is a quadrant part on an upper right side of FIG. 5, the divided portion D3, which is a quadrant part on a lower right side of FIG. 5, and the divided portion D4, which is a quadrant part on a lower left side of FIG. 5.

The second outer conductor 20B includes a second end part 32 having a circular cross-section and arranged to be fit inside the first end part 24. In the case of the first embodiment, as shown in FIG. 3, the outer peripheral surface of the second end part 32 is configured to contact the tips of the respective protrusions 28, e.g. configured to come into line contact with the flat surfaces 31 of the respective protrusions 28. With the second end part 32 arranged inside the first end part 24, the respective protrusions 28 are spot- welded by laser welding or the like. In this way, the first and second end parts 24, 32 are joined and fixed to each other.

The second outer conductor 20B is bent into a tubular shape and configured by joining both ends of a cut 25B in the circumferential direction, similarly to the first outer conductor 20A. An end part of the shielded cable 60 is accommodated inside the second outer conductor 20B. The shielded cable 60 of the first embodiment is configured by successively laminating a core wire 61, a coating 62, a braided wire 63 (shield layer) and a sheath 64 from a radially central side as shown in FIG. 1. In the end part of the shielded cable 60, the sheath 64 is removed, a sleeve 65 is fit, and the braided wire 63 is folded onto an outer peripheral side of the sleeve 65. The second outer conductor 20B is crimped and connected to the folded braided wire 63 using the sleeve 65 as an underlay.

As shown in FIG. 6, a crimping piece 33 is formed to project on one end in the circumferential direction of the second outer conductor 20B. The crimping piece 33 is overlapped and fixed to an outer peripheral part of the second outer conductor 20B located on a side opposite across the cut 25B in the above crimping step as shown in FIG. 2. The second outer conductor 20B maintains the tubular shape by the fixing action of the crimping piece 33 and concave convex fitting of locking portions 21B at the cut 25B.

The second outer conductor 20B includes a locking recess 34 having a constricted shape reduced in diameter over an entire circumference at a position adjacent to the second end part 32 from behind and forward of the crimping piece 33. Although not shown, the shield terminal 10 is lockable by the entrance of a locking lance of the housing into locking recess 34 when being accommodated into the housing. The shield terminal 10 is locked by the locking lance and restricted from coming out from the housing.

### Manufacturing Method of Shield Terminal 10

First, the inner conductor 11 is connected to the end part of the shielded cable 60. Subsequently, the inner conductor 11 is accommodated into the dielectric 12. Subsequently, the dielectric 12 accommodating the inner conductor 11 is inserted into the first outer conductor 20A from behind. The dielectric 12 comes into contact with the step portion 22 to be stopped in front.

In the above state, the first and second outer conductors 20A, 20B are assembled. At this time, a front end side of the second outer conductor 20B including the second end part 32 and the locking recess 34 is closed at the cut 25B, and a part behind the front end side is opened at the cut 25B as shown in FIG. 6.

In assembling the first and second outer conductors 20A, 20B, the second end part 32 of the second outer conductor 20B is inserted into the first end part 24 of the first outer conductor 20A. The second end part 32 comes into contact with the rear surface of the dielectric 12 to be stopped in front. The dielectric 12 is accommodated inside the first outer conductor 20A with movements in the front-rear direction restricted between the step portion 22 and the second end part 32 (see FIG. 1).

The tips of the respective protrusions 28 are in contact with the outer peripheral surface of the second end part 32 at four positions spaced apart in the circumferential direction. At this time, the first end part 24 can be a little deformed by opening the cut 25A. In this way, friction resistance between each first protrusion 28A and the second end part 32 can be suppressed to be small. Further, the respective stabilizers 26 can be a little deformed via the respective cut portions 27. In this way, friction resistance between each second protrusion 28B and the second end part 32 can be suppressed to be small. Thus, it can be avoided that assembly resistance of the first and second outer conductors 20A, 20B increases when the tips of the respective protrusions 28 contact the second end part 32.

Subsequently, the first end part 24 of the first outer conductor 20A and the second end part 32 of the second outer conductor 20B are joined by welding such as laser welding. In welding, the recesses 29 exposed on the outer peripheral surface of the first end part 24 can be visually confirmed and used as marks of welding points. In the case of the first embodiment, the respective protrusions 28 are in contact with the outer peripheral surface of the second end part 32. Thus, unlike the case where a clearance is formed in a radial direction between the first and second end parts 24, 32, a welding operation can be stably and accurately performed. After welding, the cut 25B on a rear side of the second outer conductor 20B is closed and, simultaneously, the second outer conductor 20B is crimped and connected to the end part of the shielded cable 60.

As described above, according to the first embodiment, the respective protrusions 28 in contact with the outer peripheral surface of the second outer conductor 20B can be used as welding points in joining the first end part 24 of the first outer conductor 20A and the second end part 32 of the second outer conductor 20B by welding such as laser welding. Thus, according to the first embodiment, the shield terminal 10 having stable quality can be provided.

In an assembly process of the first and second outer conductors 20A, 20B, the tips of the protrusions 28 can remain in contact with the second end part 32. Thus, assembly resistance needs not be increased and workability at the time of assembly can be improved. Therefore, the configuration of the first embodiment can combine the ensuring of the stability of the welded state and an improvement in workability at the time of assembly.

Each first protrusion 28A is provided in the quadrant range from the cut 25A in the circumferential direction. Further, each second protrusion 28B is provided near the cut portion 27. When the respective protrusions 28 contact the second end part 32 in the assembly process of the first and second outer conductors 20A, 20B, the first end part 24 can be deformed via the cut 25A and the cut portions 27. Thus, the configuration of the first embodiment can further suppress the assembly resistance of the first and second outer conductors 20A, 20B and workability at the time of assembly can be further improved. Further, since the flat surfaces 31 of the respective protrusions 28 contact the second end part 32, a large contact area between the first and second end parts 24, 32 can be secured and the stability of the welded state can be further improved.

Further, since the respective protrusions 28 are separately provided in the four divided portions D1 to D4 in the first end part 24, the welding points corresponding to the respective protrusions 28 can be arranged nearly at equal intervals in the circumferential direction of the first end part 24. As a result, a path for a return current can be secured in the outer conductor 20, and shielding performance of the outer conductor 20 can be properly exhibited. Further, since the respective protrusions 28 have an embossed shape and the recesses 29 are formed at the positions corresponding to the respective protrusions 28 in the outer peripheral surface of the first end part 24, the respective recesses 29 can be, for example, visually confirmed and used as the welding points. As a result, the configuration of the first embodiment can improve workability at the time of welding in welding the first and second end parts 24, 32.

### Other Embodiments of Present Disclosure

The above first embodiment disclosed this time should be considered illustrative in all aspects, rather than restrictive.

In the above first embodiment, each protrusion 28 projects to an inner peripheral side of the first end part 24 and the tip of each protrusion 28 can contact the outer peripheral surface of the second end part 32. In contrast, according to a second embodiment, each protrusion 28C may project to an outer peripheral side of a second end part 32 and the tip of each protrusion 28C may contact an inner peripheral side of a first end part 24.

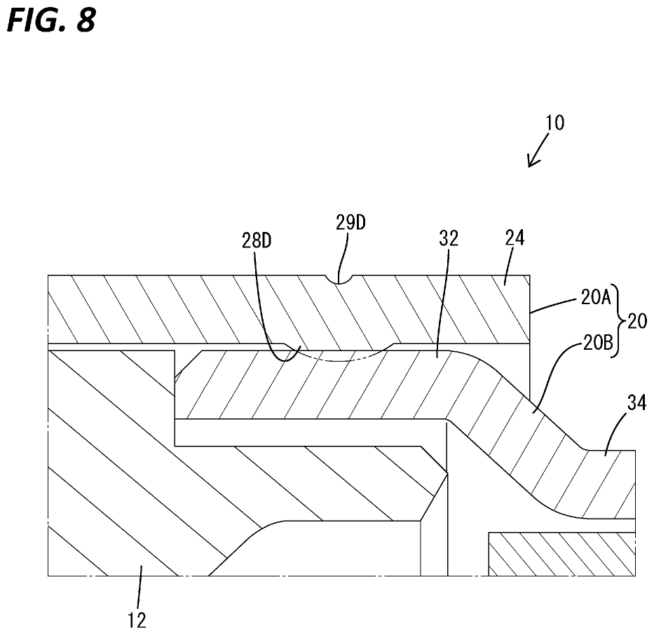

In the above first embodiment, the tip of the protrusion 28 is the flat surface 31. In contrast, according to a third embodiment, the tip of a protrusion 28D may be a curved surface as shown in FIG. 8. If the tip of the protrusion 28D is a curved surface, assembly resistance of first and second outer conductors 20A, 20B can be suppressed to be smaller. In the case of the third embodiment, a recess 29B in the form of a concave surface is formed at a position corresponding to the protrusion 28D in the outer peripheral surface of the first end part 24.

In the case of the above first embodiment, the tip of each protrusion 28 is in contact with the outer peripheral surface of the second end part 32 in a state before welding. In contrast, according to the third embodiment, the tip of each protrusion may be close to the outer peripheral surface of the second end part without contacting in the state before welding and may contact the outer peripheral surface of the second end part after welding.

In the case of the above first embodiment, four protrusions 28 are arranged nearly at equal intervals in the circumferential direction of the first end part. In contrast, less than four or more than four protrusions may be arranged at equal intervals or nearly at equal intervals of the first or second end part. Here, the more than four protrusions may be separately provided in the four divided portions in the first or second end part.

In the case of the above first embodiment, the outer conductor has a hollow cylindrical shape. In contrast, the outer conductor may have a rectangular tube shape.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shield terminal, comprising:
an inner conductor;
an outer conductor for surrounding the inner conductor; and
a dielectric to be interposed between the inner conductor and the outer conductor,
the outer conductor including a first outer conductor and a second outer conductor,
the first outer conductor having a tubular shape, the first outer conductor including a first end part,
the second outer conductor having a tubular shape, the second outer conductor including a second end part to be arranged inside the first end part, and
either one of the first and second end parts including a protrusion projecting toward the other and having a tip in contact with the other.

2. The shield terminal of claim 1, wherein:
the first end part is continuous in a circumferential direction via a cut, and
the protrusion is provided in a quadrant range in the circumferential direction from the cut in the one end part.

3. The shield terminal of claim 1, wherein:
the first end part includes a stabilizer formed by bending and raising an inner part of a cut portion formed in the first end part, and
the protrusion is provided at a position near the cut portion in the one end part.

4. The shield terminal of claim 1, wherein the tip of the protrusion is a flat surface.

5. The shield terminal of claim 1, wherein, if the one end part is equally and virtually divided into four in the circumferential direction to form four divided portions, the protrusions are respectively separately provided in the four divided portions.

6. The shield terminal of claim 1, wherein:
the protrusion is provided on the first end part, and
an outer peripheral surface of the first end part includes a recess at a position corresponding to the protrusion.
